(19) United States
(12) Patent Application Publication
(10) Pub. No.: US 2012/0007812 A1
(43) Pub. Date: Jan. 12, 2012

(54) TOUCH PANEL

(75) Inventor: Jane Hsu, Taoyuan County (TW)

(73) Assignee: DERLEAD INVESTMENT LTD., Taipei (TW)

(21) Appl. No.: 12/887,381

(22) Filed: Sep. 21, 2010

(30) Foreign Application Priority Data
Jul. 6, 2010 (TW) 099212830

(51) Int. Cl. G06F 3/041

(52) U.S. Cl. 345/173; 178/18.03

(57) ABSTRACT

A touch panel has a test point formed on one end of each of the wires formed inside the touch panel and connected to a circuit board. The test point is larger than a wire diameter of the wires and serves to be contacted by a probe of a test instrument. Even if the probe is similar to the wires in width, the wires are not cut and broken by the probe. Accordingly, after the wires of the touch panel are tested by a probe-type test instrument, the touch panel can still operate normally without having the fault arising from the broken wires inadvertently cut by a probe.

### BACKGROUND OF THE INVENTION

1. Field of the Invention

The present invention is related to a touch panel, and more particularly to a touch panel having test points being accessible and wider than a wire.

2. Description of the Related Art

Touch panels can be categorized into capacitive type, resistive type, surface acoustic wave (SAW) type and the infrared type based on the applied technologies. The capacitive touch panels and the resistive touch panels have greater market share than the other two types. What the capacitive touch panels in common with the resistive touch panels pertains to a conductive glass formed by indium tin oxide (ITO) and serving as a sensor unit. On the other hand, the capacitive touch panels differ from the resistive touch panels in that the capacitive touch panels generate a capacitive variation while the resistive touch generates a voltage variation at which the conductive glass is touched. Regardless of what type of variation, a signal resulting from the variation is outputted to a controller through a plurality of wires connected to the conductive glass. The controller can calculate the coordinates of a location being touched in accordance with the signal.

Usually, after finishing fabrication of the capacitive touch panels and the resistive touch panels, a test must be performed to check if each wire is electrically connected with the conductive glass. The test instrument currently available for such test pertains to a probe type instrument. Such test instrument has a plurality of probes serving to be respectively contacted with the wires when the test is conducted. Thus, the instrument can be electrically connected with the wires to determine if a signal generated by the conductive glass is transmitted to the corresponding wire.

As the wire size of the wires of the foregoing touch panels is relatively small and is close to a diameter of the probe, some of the wires are oftentimes poked and broken by the probe of the test instrument during testing. In this regard, it happens that the test result of a touch panel indicates a normal connection between the conductive glass and the controller while the touch panel actually fails to perform normally later due to the broken wires therebetween jabbed by the probe.

### SUMMARY OF THE INVENTION

A first objective of the present invention is to provide a single substrate touch panel having test points being greater than a wire diameter of wires.

To achieve the foregoing objective, the touch panel has a substrate. The substrate has a top surface, a bottom surface, a sensor unit and a plurality of wires. The sensor unit is formed on the top surface. The wires are mounted on the top surface of the substrate and formed by a conductive material. One end of each one of the wires is connected to the sensor unit and the other end has a test point being wider than the wire.

Preferably, the end of each one of the wires having the test point is formed on the top surface of the substrate.

Preferably, the end of each one of the wires having the test point further extends to the bottom surface of the substrate so that the test points are formed on the bottom surface of the substrate.

A second objective of the present invention is to provide a dual substrate touch panel having test points being wider than a wire.

To achieve the foregoing objective, the touch panel has a lower substrate and an upper substrate. The lower substrate has a top surface, a bottom surface, a lower sensor unit and at least one lower wire. The lower sensor is formed on the top surface. The at least one lower wire is mounted on the top surface of the lower substrate and formed by a conductive material. One end of each one of the at least one lower wire is connected to the lower sensor unit and the other end and has a first test point being wider than the lower wire.

The upper substrate has a top surface, a bottom surface, an upper sensor unit and at least one upper wire. The upper sensor is formed on the bottom surface. The at least one upper wire are mounted on the bottom surface of the upper substrate and formed by a conductive material. One end of each one of the at least one upper wire is connected to the upper sensor unit and the other end extends to the lower substrate and has a second test point formed on the lower substrate and being wider than the upper wire.

Preferably, the end of each one of the at least one upper wire having the second test point and the at least one lower wire having the first test point is formed on the top surface of the lower substrate.

Preferably, the end of each one of the at least one upper wire having the second test point and the at least one lower wire having the first test point further extends to the bottom surface of the lower substrate so that the first test point of the at least one lower wire and the second test point of the at least one upper wire and are formed on the bottom surface of the lower substrate.

Given a test point formed on one end of each one of the wires, the upper wires and the lower wires for the probe of a test instrument to contact with and being wider than the wires, the upper wire and the lower wire, the test points can be prevented from being cut and broken by the probe having a similar size to those wires. The issue that conventional touch panels are faulty for sake of broken wires being tested by the probe of the test instrument can be solved accordingly. Besides, the test points capable of being formed on the top surface or the bottom surface of the substrate facilitate the test points to be accessible to the probe.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a touch panel in accordance with the present invention;

FIG. 2 is a perspective view of a second embodiment of a touch panel in accordance with the present invention;

FIG. 3 is an exploded perspective view of a third embodiment of the touch panel in accordance with the present invention;

FIG. 4 is a perspective view of the touch panel in FIG. 3;

FIG. 5 is a perspective view of a fourth embodiment of a touch panel in accordance with the present invention;

FIG. 6 is an exploded perspective view of a fifth embodiment of the touch panel in accordance with the present invention; and

FIG. 7 is an exploded perspective view of a sixth embodiment of a touch panel in accordance with the present invention.

### DETAILED DESCRIPTION OF THE INVENTION

A touch panel in accordance with the present invention is characterized by a test point formed on one end of each one of wires formed in the touch panel for transmitting signals. Such characteristic can be applied to touch panels which are built based on various touch panel technologies, such as single substrate projected capacitive technology, dual substrate resistive technology, dual substrate projected capacitve technology, or dual substrate matrix capacitive technology. Embodiments associated with the aforementioned touch panel technologies are given as follows.

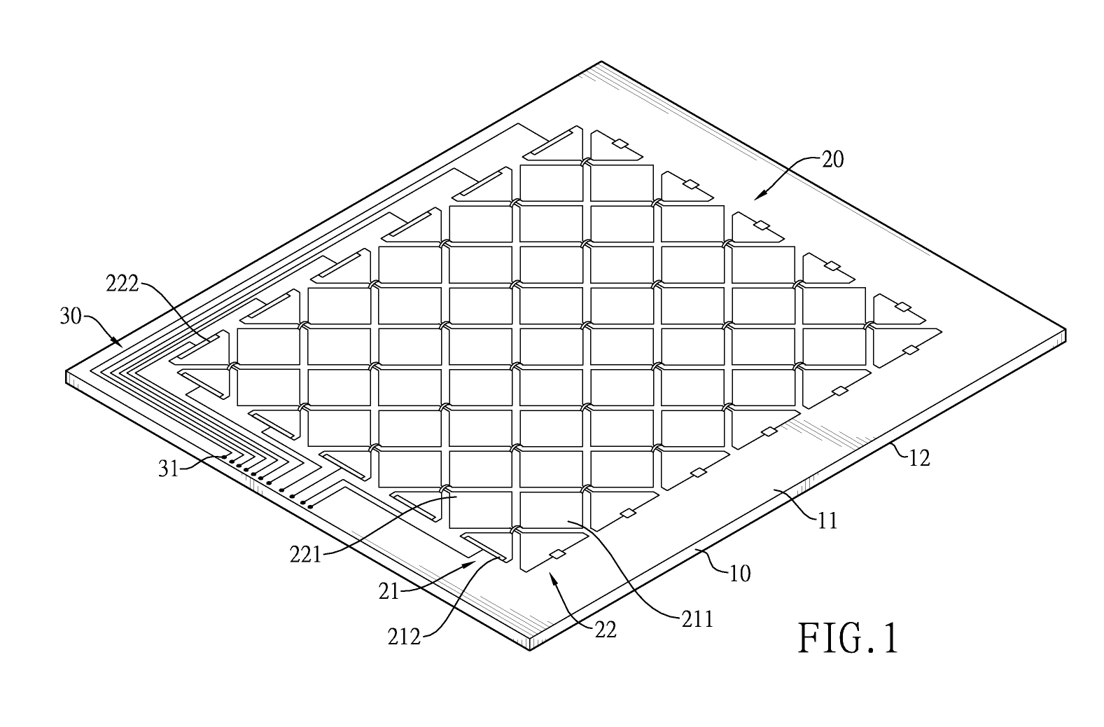

With reference to FIG. 1, being a single substrate projected capacitive touch panel, a first embodiment of a touch panel in accordance with the present invention has a substrate 10, a sensor unit 20 and a plurality of wires 30.

The substrate 10 has a top surface 11 and a bottom surface 12. The sensor unit 20 is formed on the top surface 11 and has a plurality of first conductive layers 21 and a plurality of second conductive layers 22. The first conductive layers 21 parallelly align in a first direction. Each one of the first conductive layers 21 has a plurality of sensing areas 211 and a connection port 212. The sensing areas 211 are serially connected. The connection port 212 of each one of the first conductive layers 21 is formed on an edge of an outermost sensing area 211 of the first conductive layer 21 in the first direction, and is formed by a conductive material. The second conductive layers 22 are formed on an unfilled space defined by the first conductive layers 21 and parallelly align in a second direction that is perpendicular to the first direction. Each one of the second conductive layers 22 has a plurality of sensing areas 221 and a connection port 222. The sensing areas 221 are serially connected. All of the sensor areas 221 are formed by ITO and are semi-rhombic for the bordering sensing areas 221 and rhombic between the bordering sensing areas 221. The connection port 222 of each one of the second conductive layers 22 is formed on an edge of an outermost sensing area 221 of the second conductive layer 22 in the second direction, and is formed by a conductive material.

The wires 30 are formed on the top surface 11 of the substrate 10 and are made from a conductive material. A count of the wires 30 corresponds to that of the connection ports 212, 222 on the first conductive layer 21 and the second conductive layer 22. One end of each one of the wires 30 is connected to one of the connection ports 212, 213, and the other end has a test point 31 being wider than the wires 30. In the first embodiment, the test points 31 are formed on the top surface of the substrate 10.

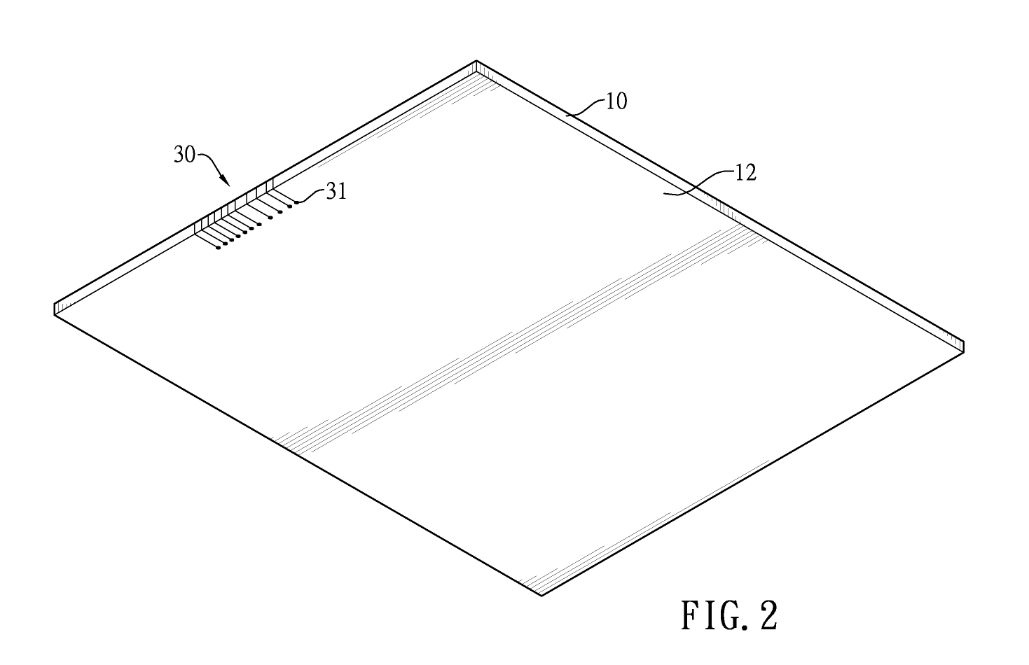

With reference to FIG. 2, in a second embodiment of a touch panel being a single substrate projected capacitive touch panel, one end of each one of the wires 30 further extends through a side edge of the substrate 10 and to the bottom surface 12 of the substrate 10, and has a test point 31 being wider than the wire 30. Therefore, the test points 31 are formed on the bottom surface 12.

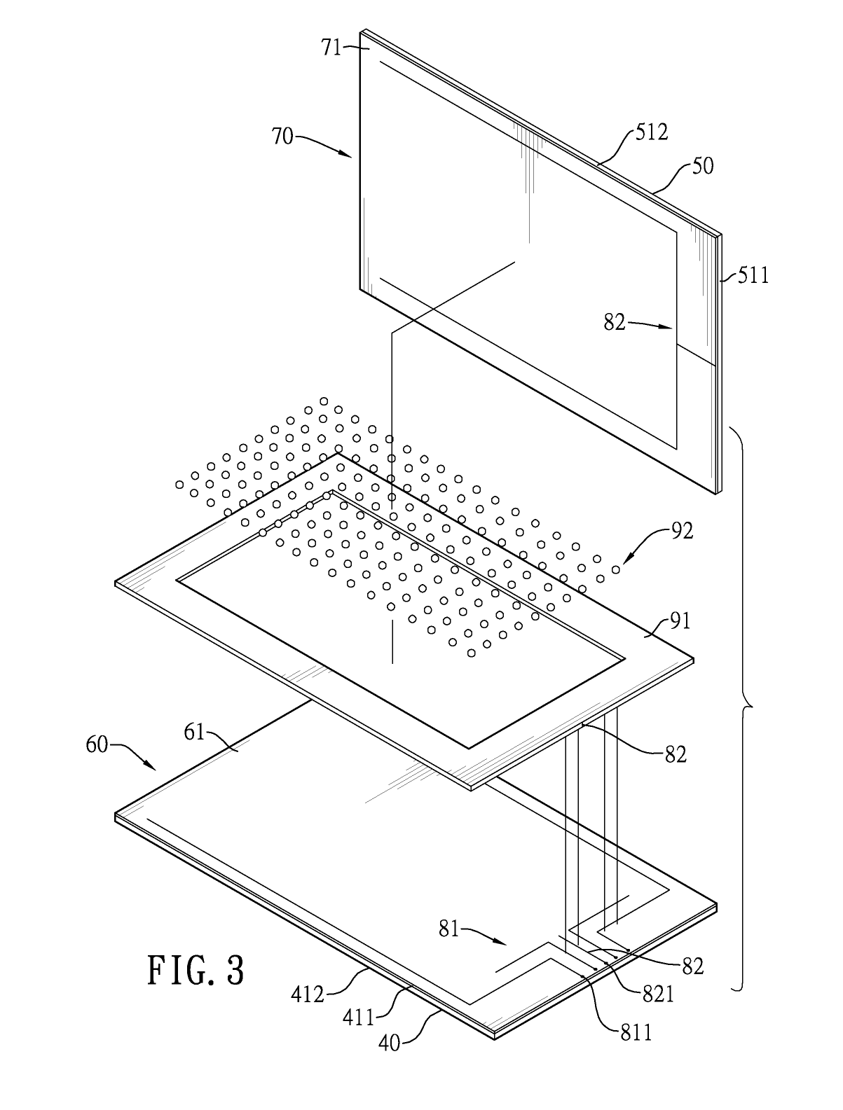

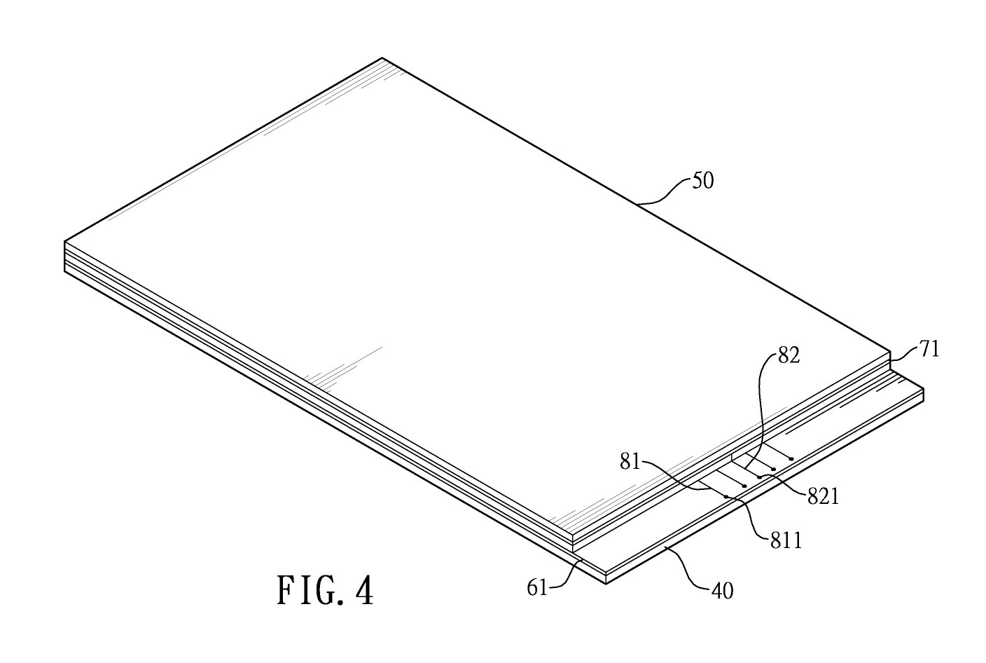

With reference to FIGS. 3 and 4, being a double substrate resistive touch panel, a third embodiment of a touch panel has a lower substrate 40, an upper substrate 50, a lower sensor unit 60, an upper sensor unit 70, an insulation layer 91, a separation layer 92, at least one lower wire 81 and at least one upper wire 82.

The lower substrate 40 has a top surface 411 and a bottom surface 412. The upper substrate 50 has a top surface 511 and a bottom surface 512. The bottom surface 512 of the upper substrate 50 faces the top surface 411 of the lower substrate 40. The lower sensor unit 60 is formed on the top surface 411 of the lower substrate 40 and has a lower conductive layer 61 formed by ITO.

The upper sensor unit 70 is formed on the bottom surface 512 of the upper substrate 50 and has an upper conductive layer 71 formed by ITO. The insulation layer 91 is frame-shaped, matches the size of the upper substrate 50, is mounted between the upper substrate 50 and the lower substrate 40, and is overlapped on the upper substrate 50. The separation layer 92 is mounted between the upper substrate 50 and the lower substrate 40 and within the insulation layer 91.

As a size of the lower substrate 40 is greater than that of the upper substrate 50, one end portion on the top surface 411 of the lower substrate 40 protrudes beyond a boundary of the upper substrate 50. Given a 5-wire resistive touch panel as an example, four lower wires 81 are formed on the top surface 411 of the lower substrate 40. One end of each one of the lower wires 81 is formed on the lower conductive layer 61, and the other end is formed on the exposed end portion and has a first test point 811 being wider than the lower wire 81. The upper substrate 50 has only one upper wire 82 formed thereon. One end of the upper wire 82 is formed on the upper conductive layer 71, and the other end extends to the exposed end portion on the top surface 411 of the lower substrate 40 through an edge of the insulation layer 91 abutting the exposed end portion. A second test point 821 is formed on the end of the upper wire 82 on the lower substrate 40 and is wider than the upper wire 82. In the third embodiment, the first test points 811 and the second test point 821 are formed on the top surface of the lower substrate 40.

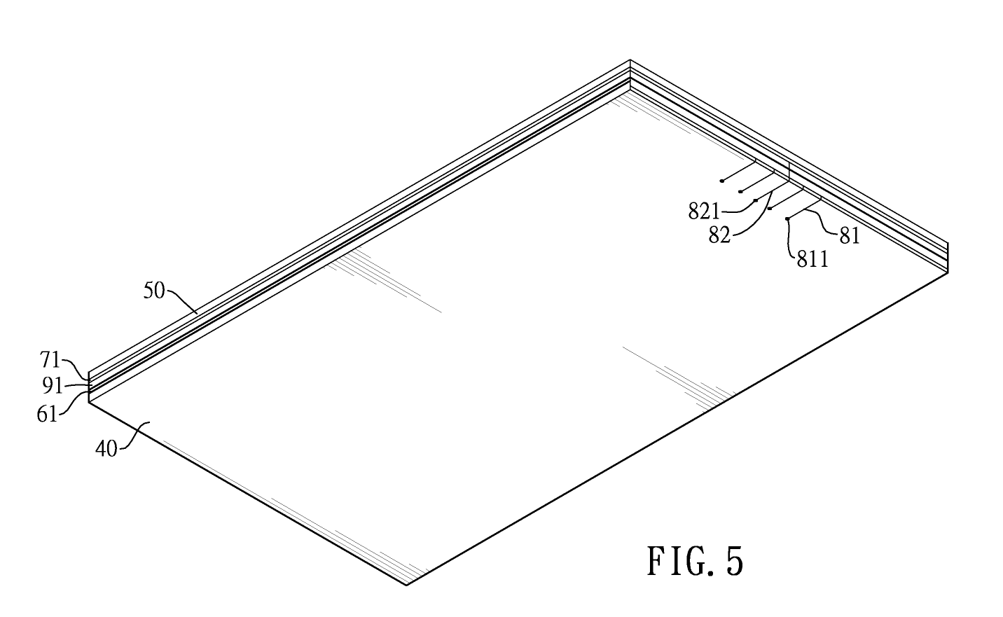

With reference to FIG. 5, a fourth embodiment of a touch panel is a double substrate resistive touch panel and is similar to the third embodiment of the double substrate resistive touch panel. In the fourth embodiment, the size of the lower substrate 40 matches that of the upper substrate 50. One end of the upper wire 82 having the second test point 821 further extends to the bottom surface 412 of the lower substrate 40 through the insulation layer 91, the lower conductive layer 61 and an edge of the lower substrate 40. One end of the lower wire 81 having the first test point 811 extends to the bottom surface 412 of the lower substrate 40 through the edge of the lower substrate 40. In the fourth embodiment, the first test points 811 and the second test point 821 are formed on the bottom surface 412 of the lower substrate 40.

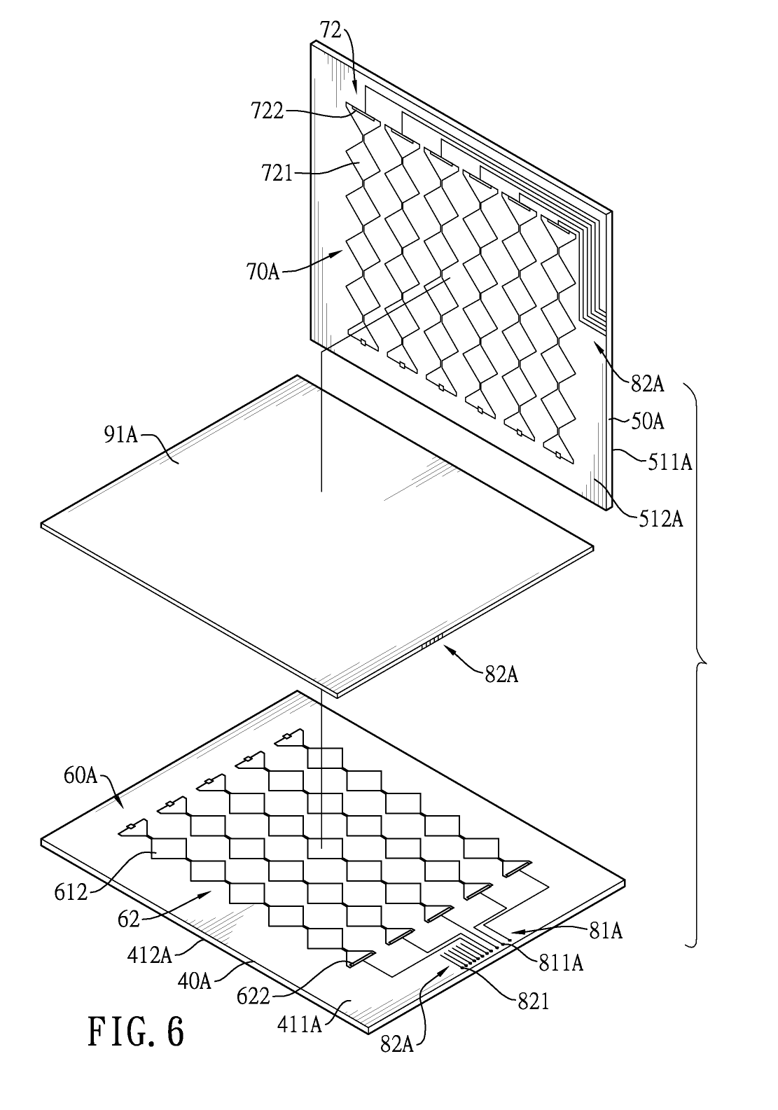

With reference to FIG. 6, being a projected capacitive panel, a fifth embodiment of a touch panel in accordance with the present invention has a lower substrate 40A, an upper substrate 50A, a lower sensor unit 60A, an upper sensor unit 70A, an insulation layer 91A, a plurality of lower wires 81A, and a plurality of upper wires 82A. Each one of the lower substrate 40A and the upper substrate 50A has a top surface 411A, 511A and a bottom surface 412A, 512A. The bottom surface 512A of the upper substrate 50A faces the top surface 411A of the lower substrate 40A. The lower sensor unit 60A is formed on the top surface 411A of the lower substrate 40A and has a plurality of lower conductive layers 62. The lower conductive layers 62 parallelly align in a first direction. Each one of the lower conductive layers 62 has a plurality of lower sensing areas 621 and a lower connection port 622. The lower sensing areas 621 are serially connected and formed by ITO and are semi-rhombic for the bordering lower sensing areas 621 and rhombic between the bordering lower sensing areas 621. The lower connection port 622 of each one of the lower conductive layers 62 is formed on an edge of an outermost sensing area 621 of the lower conductive layer 62 in the first direction, and is formed by a conductive material. The upper sensor unit 70A is formed on the bottom surface 512A of the upper substrate 50A and has a plurality of upper conductive layers 72. The upper conductive layers 72 parallelly align in a second direction that is perpendicular to the first direction. Each one of the upper conductive layers 72 has a plurality of upper sensing areas 721 and an upper connection port 722. The upper sensing areas 721 are serially connected and formed by ITO and are semi-rhombic for the bordering upper sensing areas 721 and rhombic between the bordering upper sensing areas 721. The upper connection port 722 of each one of the upper conductive layers 72 is formed on an edge of an outermost sensing area 721 of the upper conductive layer 72 in the second direction, and is formed by a conductive material.

The insulation layer 91A matches the size of the upper substrate 50A, is mounted between the upper substrate 50A and the lower substrate 40A, and is overlapped on the upper substrate 50A.

When a size of the lower substrate 40A is larger than that of the upper substrate 50A as shown in FIG. 6, one end portion on the top surface 411A of the lower substrate 40A protrudes beyond a boundary of the upper substrate 50A. The lower wires 81A are formed on the top surface 411A of the lower substrate 40A and the count of the lower wires 81A corresponds to that of the lower connection ports 622. One end of each one of the lower wires 81A is connected with the corresponding lower connection port 622. The other end is formed on the exposed end portion and has a first test point 811A being wider than the lower wire 81A. The upper wires 82A are formed on the bottom surface 512A of the upper substrate 50A and the count of the upper wires 82A corresponds to that of the upper connection port 722. One end of each one of the upper wires 82A is connected with the corresponding upper connection port 722. The other end extends to the exposed end portion on the top surface 411A of the lower substrate 40A through an edge of the insulation layer 91A abutting the exposed end portion. A second test point 821A is formed on the end of each one of the upper wire 82A on the lower substrate 40A and is wider than the upper wire 82A. In the fifth embodiment, the first test points 811A and the second test points 821A are formed on the top surface 411A of the lower substrate 40A.

Despite not shown in FIG. 6 due to the similarity as in FIG. 5, when the size of the lower substrate 40A matches that of the upper substrate 50A, the end of the upper wire 82A having the second test point 821A extends to the bottom surface 412A of the lower substrate 40A through the insulation layer 91A, the lower conductive layer 62 and an edge of the lower substrate 40A. The second test point 821A is wider than the upper wire 82A. The end of the lower wire 81A having the first test point 811A extends to the bottom surface 412A of the lower substrate 40A through the edge of the lower substrate 40A. The first test point 811A is wider than the upper wire 81A. When the lower substrate 40A matches the upper substrate 50A in size, the first test points 811A and the second test points 821A are formed on the bottom surface 412A of the lower substrate 40A.

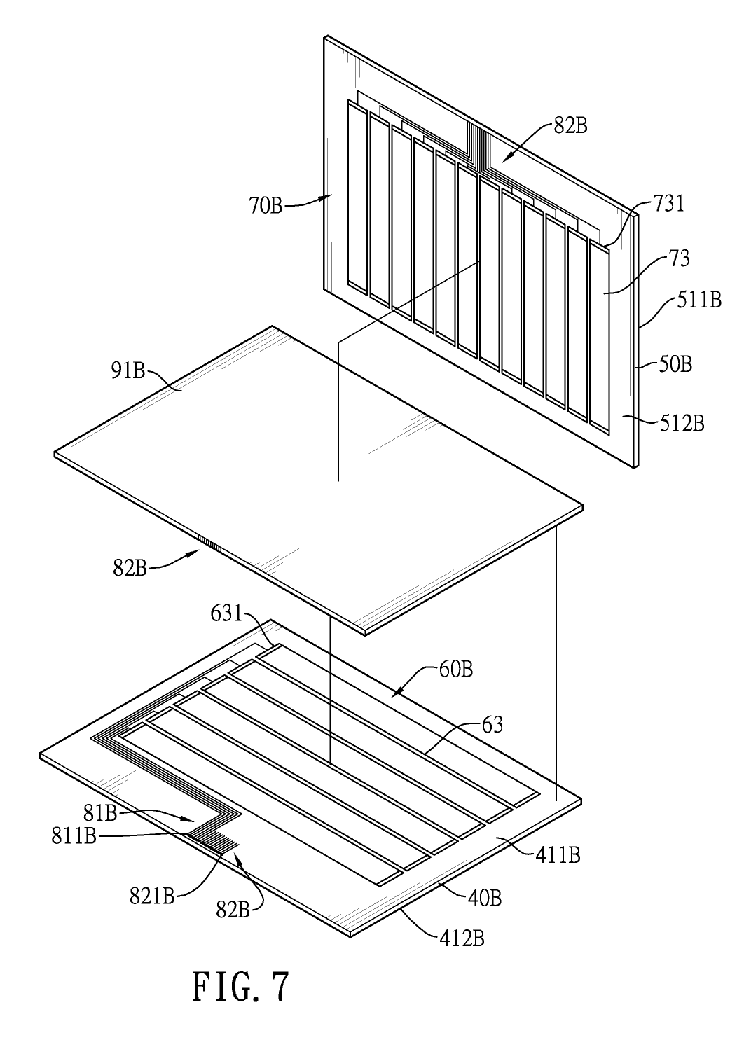

With reference to FIG. 7, being a matrix capacitive touch panel, a sixth embodiment of a touch panel in accordance with the present invention has a lower substrate 40B, an upper substrate 50B, a lower sensor unit 60B, an upper sensor unit 70B, an insulation layer 91B, a plurality of lower wires 81B, and a plurality of upper wires 82B. Each one of the lower substrate 40B and the upper substrate 50B has a top surface 411B, 511B and a bottom surface 412B, 512B. The bottom surface 512B of the upper substrate 50B faces the top surface 411B of the lower substrate 40B. The lower sensor unit 60B is formed on the top surface 411B of the lower substrate 40B and has a plurality of juxtaposed lower conductive layers 63. The lower conductive layers 63 are rectangular, align in a first direction, and are formed by ITO. Each one of the lower conductive layers 63 has a lower connection port 631. The lower connection port 631 is formed on one side of the corresponding lower conductive layer 63 that is perpendicular to the first direction and is made from a conductive material. The upper sensor unit 70B is formed on the bottom surface 512B of the upper substrate 50B and has a plurality of juxtaposed upper conductive layers 73. The upper conductive layers 73 are rectangular, align in a second direction that is perpendicular to the first direction, are formed by ITO, and are intersected with the lower conductive layers 63 in a form of columns and rows of a matrix. Each one of the upper conductive layers 73 has an upper connection port 731. The upper connection port 731 is formed on one side of the corresponding upper conductive layer 73 that is perpendicular to the second direction and is made from a conductive material.

The insulation layer 91B matches the size of the upper substrate 50B, is mounted between the upper substrate 50B and the lower substrate 40B, and is overlapped on the upper substrate 50B.

When a size of the lower substrate 40B is larger than that of the upper substrate 50B as shown in FIG. 7, one end portion on the top surface 411B of the lower substrate 40B protrudes beyond a boundary of the upper substrate 50B. The lower wires 81B are formed on the top surface 411B of the lower substrate 40B and the count of the lower wires 81B corresponds to that of the lower connection ports 622. One end of each one of the lower wires 81B is connected with the corresponding lower connection port 631. The other end is formed on the exposed end portion and has a first test point 811B being wider than the lower wire 81B. The upper wires 82B are formed on the bottom surface 512B of the upper substrate 50B and the count of the upper wires 82B corresponds to that of the upper connection ports 731. One end of each one of the upper wires 82B is connected with the corresponding upper connection port 731. The other end extends to the exposed end portion on the top surface 411B of the lower substrate 40B through an edge of the insulation layer 91B abutting the exposed end portion. A second test point 821B is formed on the end of the upper wire 82B on the lower substrate 40B and is wider than the upper wire 82B. In the sixth embodiment, the first test points 811B and the second test points 821B are formed on the top surface 411B of the lower substrate 40B.

Despite not illustrated in FIG. 7 due to the similarity as in FIG. 5, when the size of the lower substrate 40B matches that of the upper substrate 50B, the end of the upper wire 82B having the second test point 822B extends to the bottom surface 412B of the lower substrate 40B through the insulation layer 91B, the lower conductive layer 63 and an edge of the lower substrate 40B and has a second test point 822B being wider than the upper wire 82B. The end of the lower wire 81B having the first test point 811B extends to the bottom surface 412B of the lower substrate 40B through the edge of the lower substrate 40B. The first test point 811B is wider than the upper wire 81B. When the lower substrate 40B matches the upper substrate 50B in size, the first test points 811B and the second test points 821B are formed on the bottom surface 412B of the lower substrate 40A.

The touch panel of the present invention has a test point formed on one end of each one of the wires, the upper wires and the lower wires. Those test points are available for the probe of test instrument to contact with. As the test points are wider than the wires, the upper wires and the lower wires, the test points are not poked and broken by the probe having a similar size to those wires. Accordingly, the present invention can prevent the issue that conventional touch panels are faulty due to broken wires after the wires are tested by a probe-type test instrument. Moreover, being exposed, the test points of the present invention are located on the bottom surface of the lower substrate or on a portion of the top surface of the lower substrate protruding beyond the upper substrate. Therefore, when the test points are further connected with a circuit board for outputting signals, the circuit board is unnecessarily sandwiched between the upper substrate and the lower substrate, securing a tight bonding of the upper and lower substrates and preventing a reduced touch sensitivity caused by air penetrating from the gaps between the circuit board and the upper substrate as well as between the circuit board and the lower substrate.

Besides, after test, the test points can be integrated with a circuit of a machine (for example: touch TV, mobile phone, e-book and the like) without having to worry about finding a place for placing and integrating the circuit board.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A touch panel, comprising:
a substrate having:
a top surface;
a bottom surface;
a sensor unit formed on the top surface; and
a plurality of wires mounted on the top surface of the substrate and formed by a conductive material, wherein one end of each one of the wires is connected to the sensor unit and the other end has a test point being wider than the wire.

2. The touch panel as claimed in claim 1, wherein the end of each one of the wires having the test point is formed on the top surface of the substrate.

3. The touch panel as claimed in claim 1, wherein the end of each one of the wires having the test point extends to the bottom surface of the substrate, so that the test points are formed on the bottom surface of the substrate.

4. The touch panel as claimed in claim 1, wherein the sensor unit has:
a plurality of first conductive layers parallelly aligning in a first direction and defining an unfilled space, each one of the first conductive layers having:
a plurality of sensing areas serially connected; and
a connection port formed on an edge of an outermost sensing area of the first conductive layer in the first direction and formed by a conductive material; and
a plurality of second conductive layers formed on the unfilled space and parallelly aligning in a second direction being perpendicular to the first direction, each one of the second conductive layers having:
a plurality of sensing areas serially connected; and
a connection port formed on an edge of an outermost sensing area of the second conductive layer in the second direction and formed by a conductive material; and
a count of the wires corresponds to that of the connection ports on the first conductive layer and the second conductive layer, the end of each one of the wires connected to the sensor unit is connected to the corresponding connection port.

5. The touch panel as claimed in claim 2, wherein the sensor unit has:
a plurality of first conductive layers parallelly aligning in a first direction and defining an unfilled space, each one of the first conductive layers having:
a plurality of sensing areas serially connected; and
a connection port formed on an edge of an outermost sensing area of the first conductive layer in the first direction and formed by a conductive material; and
a plurality of second conductive layers formed on the unfilled space and parallelly aligning in a second direction being perpendicular to the first direction, each one of the second conductive layers having:
a plurality of sensing areas serially connected; and
a connection port formed on an edge of an outermost sensing area of the second conductive layer in the second direction and formed by a conductive material; and
a count of the wires corresponds to that of the connection ports on the first conductive layer and the second conductive layer, the end of each one of the wires connected to the sensor unit is connected to the corresponding connection port.

6. The touch panel as claimed in claim 3, wherein the sensor unit has:
a plurality of first conductive layers parallelly aligning in a first direction and defining an unfilled space, each one of the first conductive layers having:
a plurality of sensing areas serially connected; and
a connection port formed on an edge of an outermost sensing area of the first conductive layer in the first direction and formed by a conductive material; and
a plurality of second conductive layers formed on the unfilled space and parallelly aligning in a second direction being perpendicular to the first direction, each one of the second conductive layers having:
a plurality of sensing areas serially connected; and
a connection port formed on an edge of an outermost sensing area of the second conductive layer in the second direction and formed by a conductive material; and
a count of the wires corresponds to that of the connection ports on the first conductive layer and the second conductive layer, the end of each one of the wires connected to the sensor unit is connected to the corresponding connection port.

7. A touch panel, comprising:
a lower substrate having:
a top surface;
a bottom surface;
a lower sensor unit formed on the top surface; and
at least one lower wire mounted on the top surface of the lower substrate and formed by a conductive material, wherein one end of each one of the at least one lower wire is connected to the lower sensor unit and the other end has a first test point being wider than the lower wire; and
an upper substrate having:
a top surface;
a bottom surface facing the top surface of the lower substrate;
an upper sensor unit formed on the bottom surface; and
at least one upper wire mounted on the bottom surface of the upper substrate and formed by a conductive material, wherein one end of each one of the at least one upper wire is connected to the upper sensor unit and the other end extends to the lower substrate and has a second test point being wider than the upper wire.

8. The touch panel as claimed in claim 7, wherein the end of each one of the at least one upper wire having the second test point and the at least one lower wire having the first test point is formed on the top surface of the lower substrate.

9. The touch panel as claimed in claim 7, wherein
the end of each one of the at least one upper wire having the second test point and the at least one lower wire having the first test point further extends to the bottom surface of the lower substrate so that the first test point of the at least one lower wire and the second test point of the at least one upper wire and are formed on the bottom surface of the lower substrate.

10. The touch panel as claimed in claim 7, further comprising:
an insulation layer being frame-shaped, corresponding to the upper substrate, mounted between the upper substrate and the lower substrate, and overlapped on the upper substrate; and
a separation layer mounted between the upper substrate and the lower substrate and within the insulation layer;
wherein
the lower sensor unit on the top surface of the lower substrate has a lower conductive layer, the end of each one of the lower wires connected to the lower sensor unit is formed on the lower conductive layer; and
the upper sensor unit on the bottom surface of the upper substrate has an upper conductive layer, one end of the upper wire connected to the upper sensor unit is formed on the upper conductive layer.

11. The touch panel as claimed in claim 8, further comprising:
an insulation layer being frame-shaped, corresponding to the upper substrate, mounted between the upper substrate and the lower substrate, and overlapped on the upper substrate; and
a separation layer mounted between the upper substrate and the lower substrate and within the insulation layer;
wherein
the lower sensor unit on the top surface of the lower substrate has a lower conductive layer, the end of each one of the lower wires connected to the lower sensor unit is formed on the lower conductive layer; and
the upper sensor unit on the bottom surface of the upper substrate has an upper conductive layer, one end of the upper wire connected to the upper sensor unit is formed on the upper conductive layer.

12. The touch panel as claimed in claim 9, further comprising:
an insulation layer being frame-shaped, corresponding to the upper substrate, mounted between the upper substrate and the lower substrate, and overlapped on the upper substrate; and
a separation layer mounted between the upper substrate and the lower substrate and within the insulation layer;
wherein
the lower sensor unit on the top surface of the lower substrate has a lower conductive layer, the end of each one of the lower wires connected to the lower sensor unit is formed on the lower conductive layer; and
the upper sensor unit on the bottom surface of the upper substrate has an upper conductive layer, one end of the upper wire connected to the upper sensor unit is formed on the upper conductive layer.

13. The touch panel as claimed in claim 7, further comprising:
an insulation layer matching the upper substrate in size, mounted between the upper substrate and the lower substrate, and overlapped on the upper substrate;
wherein
the lower sensor unit on the top surface of the lower substrate has:
a plurality of lower conductive layers parallelly aligning in a first direction, each one of the lower conductive layers having:
a plurality of lower sensing areas serially connected; and
a lower connection port formed on an edge of an outermost sensing area of the lower conductive layer in the first direction;
a count of the lower wires corresponds to that of the lower connection ports, and the end of each one of the lower wires connected to the lower sensor unit is connected to the corresponding lower connection port;
the upper sensor unit on the bottom surface of the upper substrate has:
a plurality of upper conductive layers parallelly aligning in a second direction being perpendicular to the first direction, each one of the upper conductive layers having:
a plurality of upper sensing areas serially connected; and
an upper connection port formed on an edge of an outermost sensing area of the upper conductive layer in the second direction; and
a count of the upper wires corresponds to that of the upper connection ports, and the end of each one of the upper wires connected to the upper sensor unit is connected to the corresponding upper connection port.

14. The touch panel as claimed in claim 8, further comprising:
an insulation layer matching the upper substrate in size, mounted between the upper substrate and the lower substrate, and overlapped on the upper substrate;
wherein
the lower sensor unit on the top surface of the lower substrate has:
a plurality of lower conductive layers parallelly aligning in a first direction, each one of the lower conductive layers having:
a plurality of lower sensing areas serially connected; and
a lower connection port formed on an edge of an outermost sensing area of the lower conductive layer in the first direction;
a count of the lower wires corresponds to that of the lower connection ports, and the end of each one of the lower wires connected to the lower sensor unit is connected to the corresponding lower connection port;
the upper sensor unit on the bottom surface of the upper substrate has:
a plurality of upper conductive layers parallelly aligning in a second direction being perpendicular to the first direction, each one of the upper conductive layers having:
a plurality of upper sensing areas serially connected; and
an upper connection port formed on an edge of an outermost sensing area of the upper conductive layer in the second direction; and
a count of the upper wires corresponds to that of the upper connection ports, and the end of each one of the upper wires connected to the upper sensor unit is connected to the corresponding upper connection port.

15. The touch panel as claimed in claim 9, further comprising:
an insulation layer matching the upper substrate in size, mounted between the upper substrate and the lower substrate, and overlapped on the upper substrate;
wherein
the lower sensor unit on the top surface of the lower substrate has:
a plurality of lower conductive layers parallelly aligning in a first direction, each one of the lower conductive layers having:
a plurality of lower sensing areas serially connected; and
a lower connection port formed on an edge of an outermost sensing area of the lower conductive layer in the first direction;
a count of the lower wires corresponds to that of the lower connection ports, and the end of each one of the lower wires connected to the lower sensor unit is connected to the corresponding lower connection port;
the upper sensor unit on the bottom surface of the upper substrate has:
a plurality of upper conductive layers parallelly aligning in a second direction being perpendicular to the first direction, each one of the upper conductive layers having:
a plurality of upper sensing areas serially connected; and
an upper connection port formed on an edge of an outermost sensing area of the upper conductive layer in the second direction; and
a count of the upper wires corresponds to that of the upper connection ports, and the end of each one of the upper wires connected to the upper sensor unit is connected to the corresponding upper connection port.

16. The touch panel as claimed in claim 7, further comprising:
an insulation layer matching the upper substrate in size, mounted between the upper substrate and the lower substrate, and overlapped on the upper substrate;
wherein
the lower sensor unit on the top surface of the lower substrate has:
a plurality of juxtaposed lower conductive layers being rectangular and aligning in a first direction, each one of the lower conductive layers having:
a lower connection port formed on one side of the lower conductive layer that is perpendicular to the first direction;
a count of the lower wires corresponds to that of the lower connection ports, and the end of each one of the lower wires connected to the lower sensor unit is connected to the corresponding lower connection port;
the upper sensor unit on the bottom surface of the upper substrate has:
a plurality of juxtaposed upper conductive layers being rectangular and aligning in a second direction being perpendicular to the first direction, and are intersected with the lower conductive layers in a form of columns and rows of a matrix, each one of the upper conductive layers having:
an upper connection port formed on one side of the corresponding upper conductive layer that is perpendicular to the second direction; and
a count of the upper wires corresponds to that of the upper connection ports, and the end of each one of the upper wires connected to the upper sensor unit is connected to the corresponding upper connection port.

17. The touch panel as claimed in claim 8, further comprising:
an insulation layer matching the upper substrate in size, mounted between the upper substrate and the lower substrate, and overlapped on the upper substrate;
wherein
the lower sensor unit on the top surface of the lower substrate has:
a plurality of juxtaposed lower conductive layers being rectangular and aligning in a first direction, each one of the lower conductive layers having:
a lower connection port formed on one side of the lower conductive layer that is perpendicular to the first direction;
a count of the lower wires corresponds to that of the lower connection ports, and the end of each one of the lower wires connected to the lower sensor unit is connected to the corresponding lower connection port;
the upper sensor unit on the bottom surface of the upper substrate has:
a plurality of juxtaposed upper conductive layers being rectangular and aligning in a second direction being perpendicular to the first direction, and are intersected with the lower conductive layers in a form of columns and rows of a matrix, each one of the upper conductive layers having:
an upper connection port formed on one side of the corresponding upper conductive layer that is perpendicular to the second direction; and
a count of the upper wires corresponds to that of the upper connection ports, and the end of each one of the upper wires connected to the upper sensor unit is connected to the corresponding upper connection port.

18. The touch panel as claimed in claim 9, further comprising:
an insulation layer matching the upper substrate in size, mounted between the upper substrate and the lower substrate, and overlapped on the upper substrate;
wherein
the lower sensor unit on the top surface of the lower substrate has:
a plurality of juxtaposed lower conductive layers being rectangular and aligning in a first direction, each one of the lower conductive layers having:
a lower connection port formed on one side of the lower conductive layer that is perpendicular to the first direction;
a count of the lower wires corresponds to that of the lower connection ports, and the end of each one of the lower wires connected to the lower sensor unit is connected to the corresponding lower connection port;
the upper sensor unit on the bottom surface of the upper substrate has:
a plurality of juxtaposed upper conductive layers being rectangular and aligning in a second direction being perpendicular to the first direction, and are intersected with the lower conductive layers in a form of columns and rows of a matrix, each one of the upper conductive layers having:
an upper connection port formed on one side of the corresponding upper conductive layer that is perpendicular to the second direction; and
a count of the upper wires corresponds to that of the upper connection ports, and the end of each one of the upper wires connected to the upper sensor unit is connected to the corresponding upper connection port.
